(19) United States
(12) Patent Application Publication
(10) Pub. No.: US 2021/0302751 A1
(43) Pub. Date: Sep. 30, 2021

(54) REVERSIBLE EARPIECE, HEAD-MOUNTED DEVICE WITH REVERSIBLE EARPIECE AND RELATED METHOD

(71) Applicant: Brockman-Hastings LLC, Lexington, KY (US)

(72) Inventors: Edward Britt Brockman, Louisville, KY (US); Jeffrey Todd Hastings, Lexington, KY (US); Carlos Andres Jarro, Lexington, KY (US); James L. Russell, Lexington, KY (US)

(21) Appl. No.: 17/154,355

(22) Filed: Jan. 21, 2021

Related U.S. Application Data
(60) Provisional application No. 63/002,445, filed on Mar. 31, 2020.

(51) Int. Cl. G02B 27/01; G02C 5/20; G02C 5/14

(52) U.S. Cl. CPC G02B 27/0176; G02B 2027/0178; G02C 5/143; G02C 5/20

(57) ABSTRACT

A reversible earpiece for a head-mounted device includes (a) a first body section, (b) a second body section, (c) a cooperating pivot and a receiver and (d) a cooperating locking ball and a guide track. The receiver is adapted to receive and hold the pivot. The guide track is adapted to receive and hold the locking ball.

### RELATED APPLICATION

This application claims priority to U.S. Provisional Patent Application Ser. No. 63/002,445 filed on Mar. 31, 2020 which is hereby incorporated by reference in its entirety.

### GOVERNMENT SUPPORT

This invention was made with an award from the Kentucky Cabinet for Economic Development, under Grant Agreement CED 2019-001-004.

### TECHNICAL FIELD

This document relates generally to a reversible earpiece, a head-mounted device incorporating that reversible earpiece and to a related method of sequentially positioning such a head-mounted device in a first operative position in front of a first eye of an individual and a second operative position in front of a second eye of the individual.

### BACKGROUND

Reversible sunglasses and glasses of all types with folding earpieces are generally known in the art. Examples of such devices may be found in U.S. Pat. Nos. 9,726,900; 4,787,731; 6,530,660 and 7,198,366.

This document relates to a new and improved reversible earpiece incorporating a simple and inexpensive mechanism that allows for each side of a head-mounted device to be used with each eye. For example, a head-mounted device with a camera to image an eye may be easily and conveniently rotated to image the fellow eye without the need for duplicate optics and/or electronics.

As another example, a head-mounted device that communicates electronically with an intraocular implant device in an eye may be easily and conveniently rotated to communicate with a second intraocular device in the other eye without duplicating electronics. As still another example, a head-mounted device designed to provide a display for one eye can be easily and conveniently rotated to provide the display for the other eye.

Advantageously, the reversible earpiece has only one moving part. Further, the earpiece may be easily removed and exchanged or replaced with another earpiece.

### SUMMARY

In accordance with the purposes and benefits described herein, a new and improved reversible earpiece is provided for a head-mounted device. That reversible earpiece comprises: (a) a first body section, (b) a second body section having an earpiece, (c) a pivot and a receiver, wherein the receiver is adapted to receive the pivot, and (d) a locking ball and a guide track, wherein the guide track is adapted to receive the locking ball. The pivot is carried on either of the body sections and the receiver is carried on the other body section. Similarly, the locking ball is carried on either of the body sections and the guide track is carried on the other body section.

In one or more of the many possible embodiments of the reversible earpiece, the guide track includes an inlet allowing insertion of the locking ball into the guide track and removal of the locking ball from the guide track. In one or more of the many possible embodiments of the reversible earpiece, the guide track includes (a) a first detent adapted to capture and hold the locking ball in a first position at a first end of the guide track and (b) a second detent adapted to capture and hold the locking ball in a second position at a second end of the guide track. In such embodiments, the inlet may be provided in the guide track between the first end and the second end.

When the first body section and the second body section are properly joined, the guide track extends in an arc around the pivot. In one or more embodiments, the guide track extends through an arc of approximately 180 degrees.

In at least one of the many possible embodiments of the reversible earpiece, the receiver is carried on the first body section and the pivot is carried on the second body section. In one or more of the many possible embodiments of the reversible earpiece, the guide track is carried on the first body section and the locking ball is carried on the second body section.

In any of the possible embodiments of the reversible earpiece, the locking ball may include a bulbous head and a neck. In such embodiments, the guide track may include: (a) a continuous channel adapted to receive the bulbous head, (b) the first end of the guide track may include a first inlet slot adapted to receive the neck and (c) the second end of the guide track may include a second inlet slot adapted to receive the neck.

In accordance with an additional aspect, a head-mounted device is provided incorporating the reversible earpiece. That head-mounted device may comprise, but is not necessarily limited to, a receiver of electromagnetic or acoustic energy, a transmitter of electromagnetic or acoustic energy, a transceiver of electromagnetic or acoustic energy, a display or a therapeutic device that delivers electromagnetic energy to the eye. The head-mounted device may also include a reversible or two-sided nose bridge for bridging the nose between the eyes of the individual using the device.

In accordance with yet another aspect, a method is provided for sequentially positioning a head-mounted device in a first operative position in front of a first eye of an individual and a second operative position in front of a second eye of the individual. That method may include the steps of: (a) orienting reversible earpieces connected to the head-mounted device into a first position, (b) positioning the head-mounted device into the first operative position in front of the first eye, (c) reorienting the reversible earpieces connected to the head-mounted device into a second position and (d) positioning the head-mounted device into a second position in front of the second eye.

In one or more of the many possible embodiments of the method, the method may include the additional step of rotating the head-mounted device and the reversible earpieces about a rotation axis extending between the reversible earpieces before the positioning of the head-mounted device into the second position. The rotation axis may also extend through a reversible nose bridge or two-sided nose bridge carried on the head-mounted device.

In one or more of the many possible embodiments of the method, the method may also include the step of removing the head-mounted device from the first operative position before the reorienting of the reversible earpieces into the second position.

In one or more of the many possible embodiments of the method, the method may also include the step of semi-permanently securing the reversible earpieces into one of the two positions using a fixation method such as a mechanical pin or adhesive.

In one or more of the many possible embodiments of the method, the method may include the step of conducting a therapeutic procedure, a diagnostic procedure or a monitoring procedure on the first eye with the head-mounted medical device before the reorienting of the reversible earpieces into the second position. Still further, the method may include the additional step of conducting a therapeutic procedure, a diagnostic procedure or a monitoring procedure of the second eye with the head-mounted medical device after the reorienting of the reversible earpieces into the second position in front of the second eye.

In the following description, there are shown and described several preferred embodiments of the reversible earpiece, a head-mounted device incorporating that reversible earpiece and to a related method of sequentially positioning such a head-mounted device in a first operative position in front of a first eye of an individual and a second operative position in front of a second eye of the individual. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the reversible earpiece, the head-mounted device and the method and together with the description serve to explain certain principles thereof.

FIG. 1A is a detailed side elevational view of one possible embodiment of the fully assembled reversible earpiece.

FIG. 1B is a detailed cross sectional view of the (a) cooperating receiver and pivot and (b) cooperating locking ball and guide track that join the first and second body sections of the reversible earpiece together.

FIG. 2 is a detailed perspective view of the guide track and the receiver carried on the first body section.

FIG. 3 is a detailed perspective view of the pivot and locking ball carried on the second body section.

FIGS. 4A and 4B are perspective and cross sectional views illustrating how one separates the first and second body sections in order to change or replace an earpiece.

FIG. 4C illustrates the earpiece 16 in the first operative position when the locking ball is received and held in the first end of the guide track.

FIG. 4D illustrates the earpiece 16 in the second operative position when the locking ball is received and held in the second end of the guide track.

FIGS. 5A-5I illustrate the method of sequentially positioning such a head-mounted device in a first operative position in front of a first eye of an individual and a second operative position in front of a second eye of the individual.

More specifically, FIG. 5A illustrates the step of positioning the head-mounted device into the first operative position in front of the first eye.

FIGS. 5B and 5C are respective front perspective and rear perspective views of the head-mounted device in the first operative position.

FIG. 5D illustrates the step of removing the head-mounted device from the first operative position.

FIG. 5E illustrates the step of rotating the head-mounted device and the reversible earpieces about a rotation axis extending between the reversible earpieces and through the nose bridge of the device.

FIGS. 5F and 5G illustrate the step of reorienting the reversible earpieces.

FIG. 5H illustrates the step of positioning the head-mounted device into a second position in front of the second eye.

FIG. 5I illustrates the head-mounted device in the second operative position.

FIGS. 6A-6D are perspective views illustrating the folding of the reversible earpieces of the head-mounted device following use.

Reference will now be made in detail to the present preferred embodiments of the reversible earpiece, the head-mounted device incorporating that reversible earpiece and the related method, examples of which are illustrated in the accompanying drawing figures.

### DETAILED DESCRIPTION

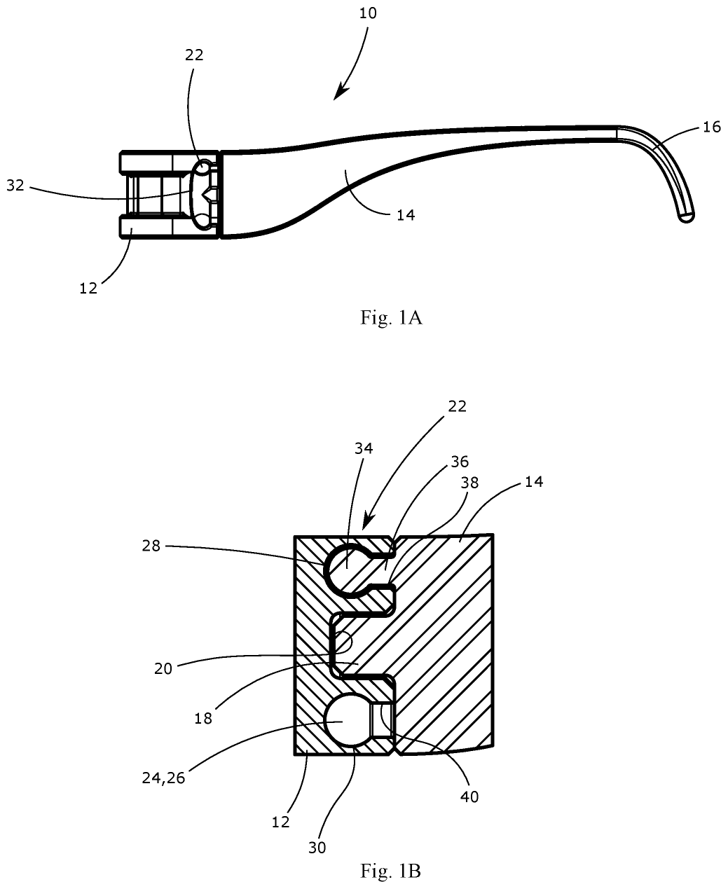

Reference is now made to FIGS. 1A, 1B, 2 and 3 illustrating one possible embodiment of the new and improved reversible earpiece 10. The reversible earpiece 10 includes a temple section or first body section 12 and a second body section 14. The second body section 14 includes an earpiece 16.

As illustrated, the first body section 12 and the second body section 14 are joined together by (a) a cooperating pivot 18 and receiver 20 and (b) a cooperating locking ball 22 and guide track 24. The pivot 18 is carried on either of the first body section 12 and the second body section 14 while the receiver 20 is carried on the other of the first body section and the second body section. Similarly, the locking ball 22 is carried on either of the first body section 12 and the second body section 14 while the guide track 24 is carried on the other of the first body section and the second body section.

In the embodiment illustrated in FIGS. 1A, 1B, 2 and 3, the pivot 18 and the locking ball 22 are carried on the second body section 14 while the receiver 20 and the guide track 24 are carried on the first body section 12. In other possible embodiments (not shown): (a) the pivot 18 and the guide track 24 are carried on the second body section 14 while the receiver 20 and the locking ball 22 are carried on the first body section, (b) the receiver 20 and the locking ball 22 are carried on the second body section 14 and the pivot 18 and guide track 24 are carried on the first body section 12 or (c) the receiver 20 and the guide track 24 are carried on the second body section 14 while the pivot 18 and the locking ball 22 are carried on the first body section 12. For purposes of this document, all four of these possible embodiments are contemplated and protected by the claims.

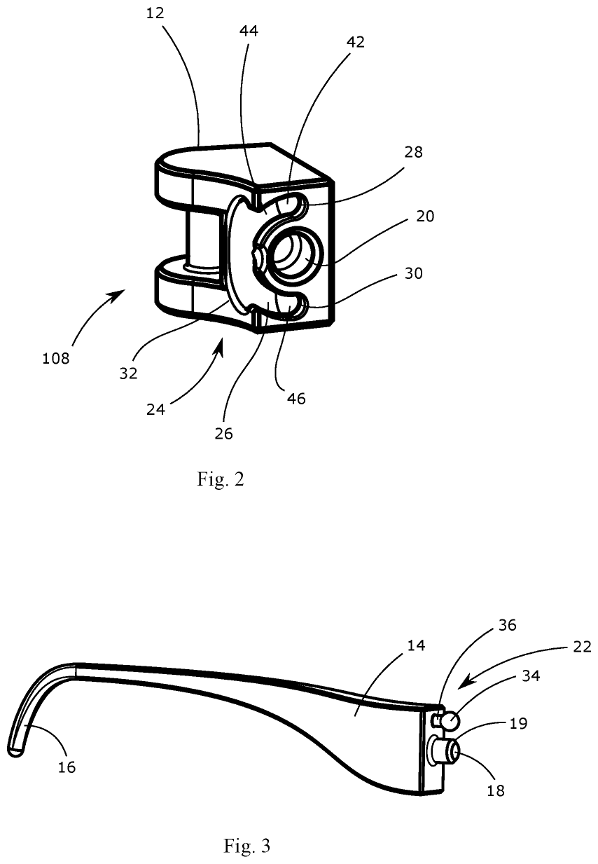

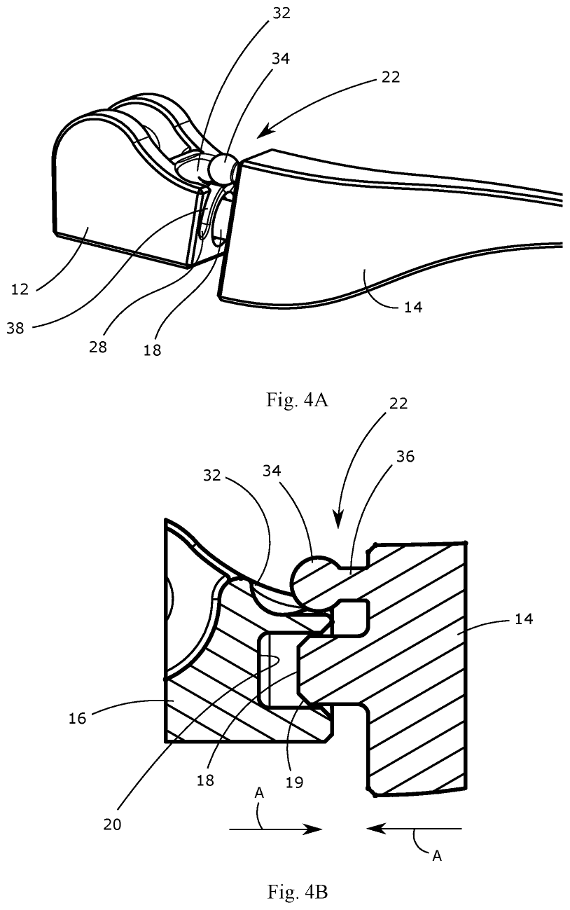

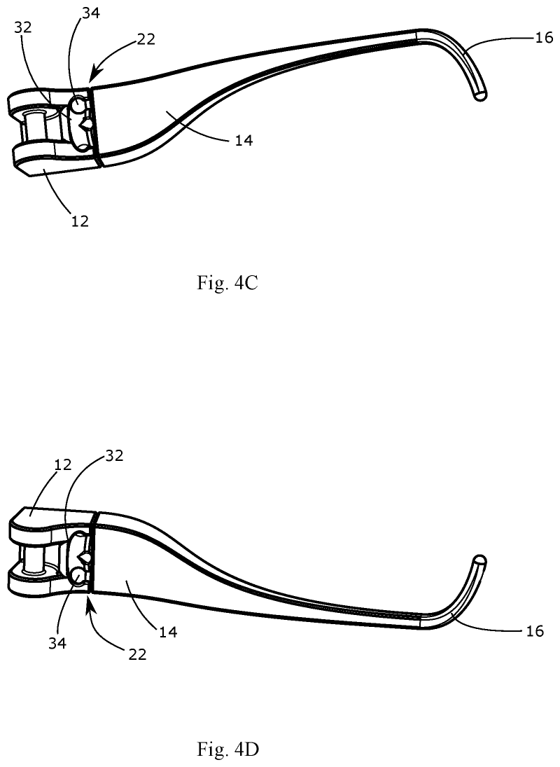

As best illustrated in FIG. 2, the guide track 24 includes a continuous channel 26 having a first end 28, a second end 30 and an inlet 32 provided between the first and the second ends. As illustrated in FIGS. 4A and 4B and described in greater detail below, the inlet 32 communicates with the continuous channel 26 and allows one to either insert the locking ball 22 into the continuous channel of the guide track 24 or remove the locking ball from the continuous channel of the guide track. Thus, one may quickly remove and/or change the second body section 14 and earpiece 16 as desired.

The locking ball 22 includes a bulbous head 34 supported on a neck 36. As should be appreciated, the bulbous head 34 has a greater cross sectional area than the narrower neck 36. The continuous channel 26 is shaped and adapted to receive the bulbous head 34. The first end 28 of the guide track 24 includes a first inlet slot 38 adapted to receive the neck 36 and prevent the passage of the bulbous head 34 from the continuous channel 26 while the second end 30 includes a second inlet slot 40 also adapted to receive the neck and prevent the passage of the bulbous head 34 from the continuous channel 26.

One joins the first body section 12 with the second body section 14 by aligning the pivot 18 with the receiver 20 and the locking ball 22 with the inlet 32 of the guide track 24. See FIGS. 4A and 4B. One then presses the two body sections 12, 14 together as illustrated by action arrows A of FIG. 4B. This forces the pivot 18 into the receiver 20 and the bulbous head 34 of the locking ball into the continuous channel 26 of the guide track. The beveled edge 19 of the pivot 18 aids in alignment and insertion of the pivot 18 into the receiver 20.

One then twists the second body section 14 with respect to the first body section 12 approximately 90 degrees in a first direction to capture the locking ball 22 in the first position at the first end 28 of the guide track 24 or approximately 90 degrees in a second direction to capture the locking ball in the second position at the second end of the guide track. When the locking ball 22 is in the first position, the earpiece 16 is in the first operative position illustrated in FIG. 4C and when the locking ball is in the second position, the earpiece is in the second operative position illustrated in FIG. 4D.

When one wants to remove or replace the second body section 14, one twists the second body section 14 with respect to the first body section 12 in order to align the locking ball 22 with the inlet 32 and then pulls the first and second body sections apart.

As should be appreciated, the guide track 24 extends through an arc of about 180 degrees centered on the pivot 18. Thus, in the first operative position, the earpiece 16 extends in a first direction (see FIG. 4C) with respect to the first body section 12 while in the second operative position, the earpiece extends in a second direction (see FIG. 4D) with respect to the first body section about 180 degrees opposite the first direction thereby making the earpiece reversible.

The inlet slots 38 and 40 at the first and second ends 28, 30 are wide enough to receive the neck 36 but are too narrow to allow the bulbous head 34 to pass through the slots. Thus, when the bulbous head 36 is at either of the first and second ends 28, 30, the two body sections 12 and 14 are secured together. A first detent 42 in the form of a cavity is provided in the wall 44 of the continuous channel 26 at the first end 28 to resist removal of the bulbous head 34 and capture and hold the locking ball 22 when the locking ball is in the first position. A second detent 46 in the form of a cavity is provided in the wall 44 of the continuous channel 26 at the second end 30 to resist removal of the bulbous head 34 and capture and hold the locking ball 22 when the locking ball is in the second position.

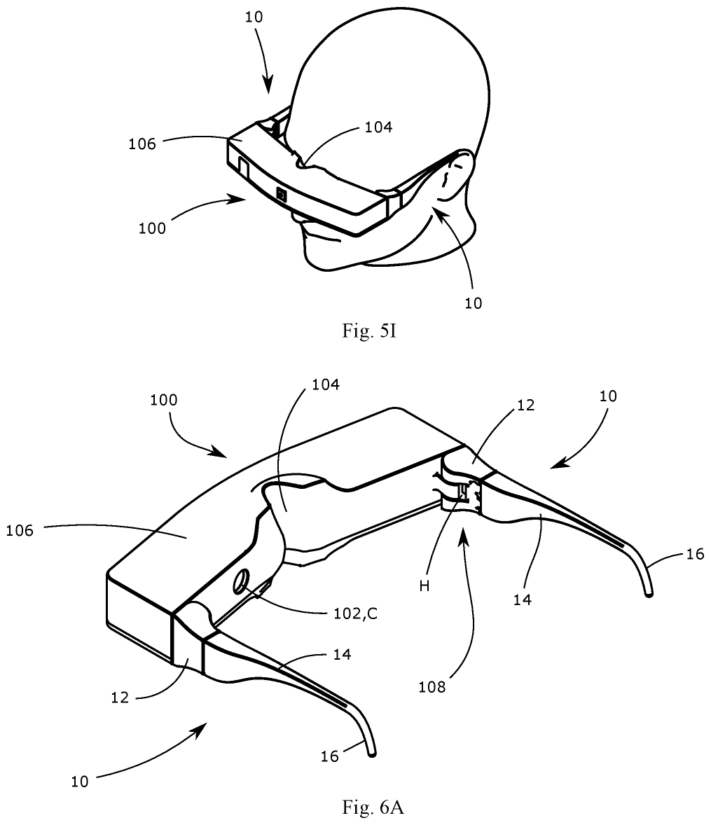

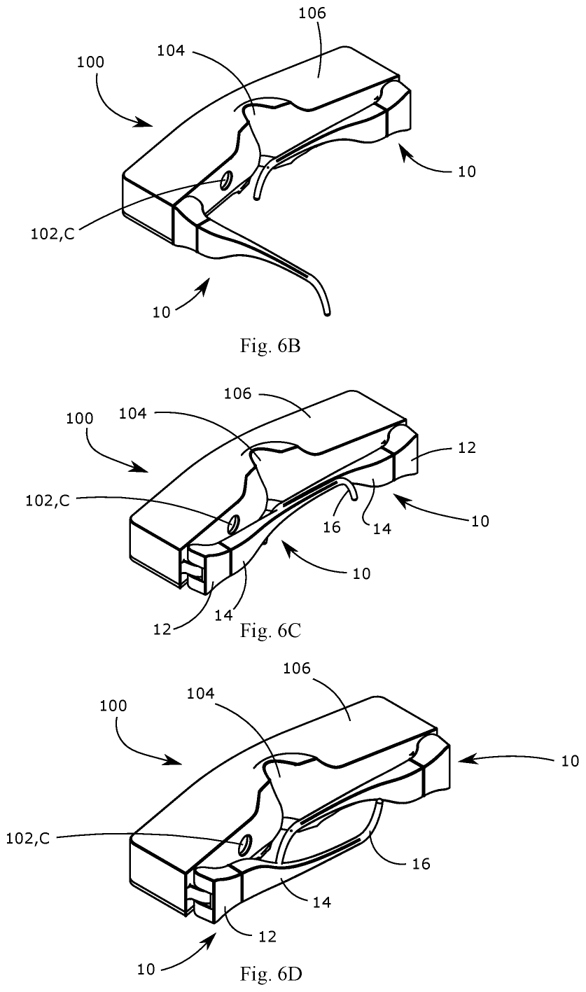

Reference is now made to FIGS. 6A-6D illustrating a head-mounted device 100 incorporating two of the reversible earpieces 10 illustrated in FIGS. 1A, 1B, 2, 3 and 4A-4D. As illustrated, the head-mounted device 100 includes an optical or other instrument 102 such as, but not necessarily limited to a camera C, an optical display or a monitoring device for communication with (a) a first intraocular device implanted within the first eye, (b) a second intraocular device implanted within the second eye or (c) a first intraocular device implanted within the first eye and a second intraocular device implanted within the second eye. In some embodiments, the head-mounted device 100 also includes a nose bridge 104. In the illustrated embodiment, the nose bridge 104 is two sided. In other embodiments, it may be reversible.

FIG. 6A-6D also illustrate how the head-mounted device 100 may be folded following use. As illustrated in FIG. 6A, the two earpieces 10 are folded outward with respect to the main body 106 of the device 100 when in use. The temple or first body sections 12 of the two reversible earpieces 10 are connected to the main body 106 by hinges H (FIG. 6A) received in the mount generally designated by reference numeral 108. This is consistent with state of the art eyeglasses construction.

Each reversible earpiece 10 is folded inward about the hinges as illustrated in FIGS. 6B and 6C so as to rest alongside the main body 106. The second body section 14 and earpiece 16 of one of the reversible earpieces 10 may then be twisted and reversed to point upward so that the earpiece 16 is fully contained within the upper and lower faces of the main body (see FIG. 6D).

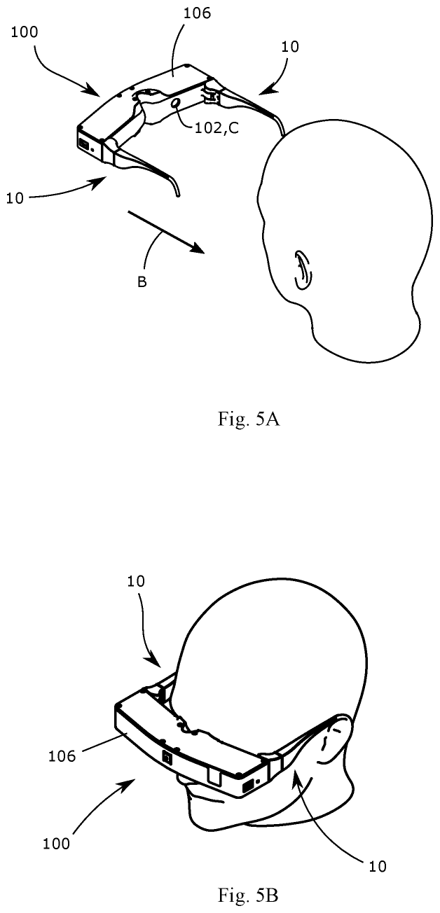

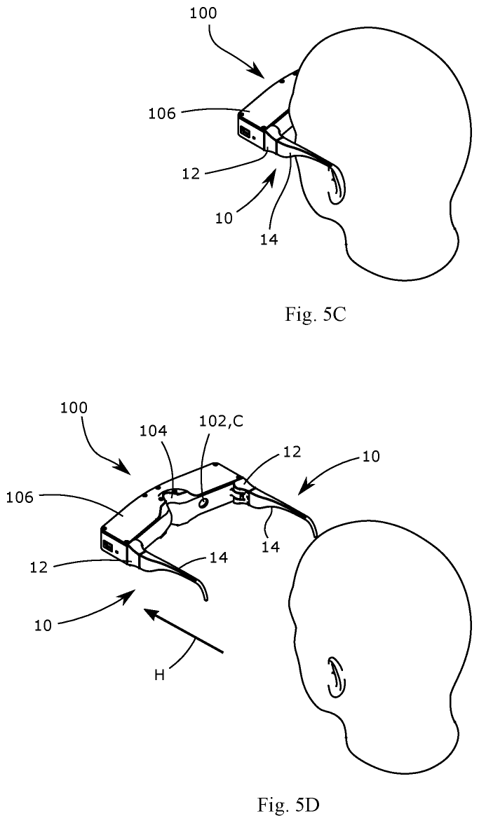

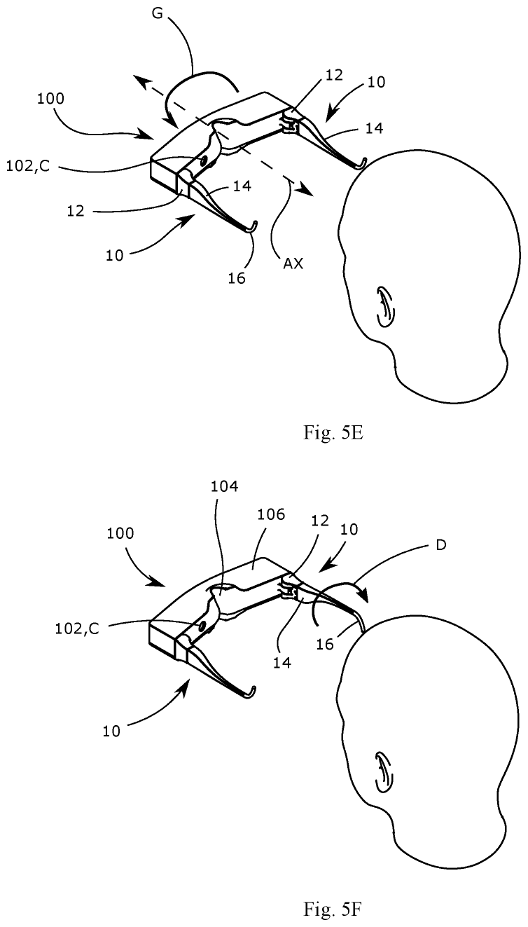

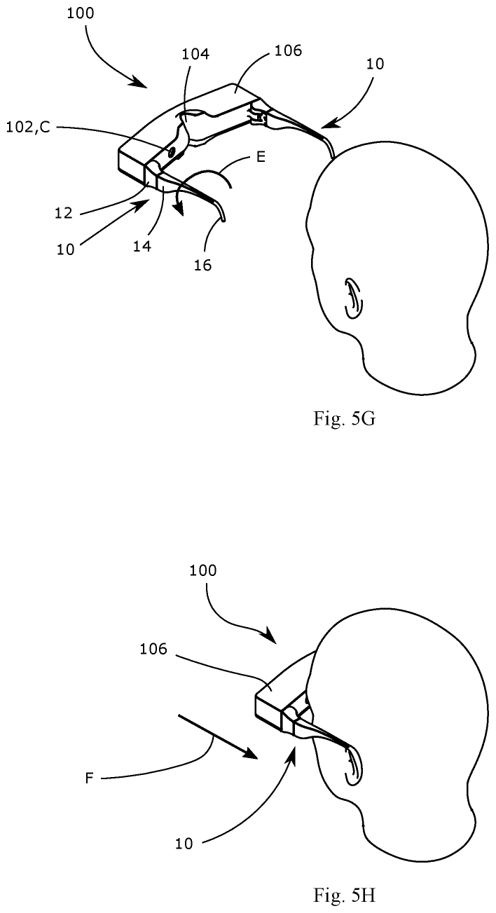

FIGS. 5A-5I effectively illustrate a method of sequentially positioning the head-mounted device 100 in a first operative position with the instrument 102 in front of a first eye of an individual and a second operative position with the instrument in front of a second eye of the individual. That method generally includes the steps of: (a) orienting the reversible earpieces 10 connected to the head-mounted device 100 into a first position as illustrated in FIG. 5A; (b) positioning the head-mounted device into the first operative position in front of the first eye E1 (again see FIG. 5A and note action arrow B); (c) reorienting the reversible earpieces connected to the head-mounted device into a second position (see FIGS. 5F and 5G and note action arrows D and E); and (d) positioning the head-mounted device into a second position in front of the second eye (see FIG. 5H and note action arrow F).

More specifically, the method may also include the step of rotating the head-mounted device 100 and the reversible earpieces about a rotation axis AX extending between the reversible earpieces 10 and through the nose bridge 104 before positioning the head-mounted device into the second position (see FIG. 5E and note action arrow G). Further, the method may also include the step of removing the head-mounted device 100 from the first operative position before the reorienting of the reversible earpieces 10 connected to the head mounted device into the second position (see FIG. 5D and note action arrow H).

Still further, the method may also include the step of conducting a medical procedure, a therapeutic procedure or a monitoring procedure of the first eye with the instrument 102 of the head-mounted device 100 before the reorienting of the reversible earpieces 10 into the second position (see FIGS. 5B and 5C). Additionally, the method may include the step of conducting a therapeutic procedure, a diagnostic procedure or a monitoring procedure of the second eye with the instrument 102 of the head-mounted device 100 after the positioning of the head-mounted device into the second position in front of the second eye (see FIG. 5D).

This disclosure is considered to relate to the following items:

1. A reversible earpiece for a head-mounted device, comprising:
a first body section;
a second body section having an earpiece;
a pivot and a receiver adapted to receive said pivot wherein said pivot is carried on either of said first body section and said second body section and said receiver is carried on the other of said first body section and said second body section; and
a locking ball and a guide track adapted to receive said locking ball wherein said locking ball is carried on either of said first body section and said second body section and said guide track is carried on the other of said first body section and said second body section.

2. The reversible earpiece of item 1, wherein said guide track includes an inlet allowing insertion of said locking ball into said guide track and removal of said locking ball from said guide track.

3. The reversible earpiece of item 2, wherein said guide track includes (a) a first detent adapted to capture and hold said locking ball in a first position at a first end of the guide track and (b) a second detent adapted to capture and hold the locking ball in a second position at a second end of said guide track.

4. The reversible earpiece of item 2, wherein when said first body section and said second body section are joined, said guide track extends in an arc around said pivot.

5. The reversible earpiece of item 4, wherein said guide track extends through an arc of about 180 degrees.

6. The reversible earpiece of item 5, wherein said inlet is provided in said guide track between said first end and said second end.

7. The reversible earpiece of item 6, wherein said receiver is carried on said first body section and said pivot is carried on said second body section.

8. The reversible earpiece of item 7, wherein said guide track is carried on said first body section and said locking ball is carried on said second body section.

9. The reversible earpiece of item 8, wherein said locking ball includes a bulbous head and a neck.

10. The reversible earpiece of item 9, wherein said guide track includes a continuous channel adapted to receive said bulbous head, said first end of said guide track includes a first inlet slot adapted to receive said neck and said second end of said guide track includes a second inlet slot adapted to receive said neck.

11. The reversible earpiece of item 1, wherein said guide track is adapted to capture and hold said locking ball in a first position at a first end of the guide track and in a second position at a second end of said guide track.

12. The reversible earpiece of item 1, wherein when said first body section and said second body section are joined, said guide track extends in an arc around said pivot.

13. The reversible earpiece of item 1, wherein said guide track extends through an arc of about 180 degrees.

14. The reversible earpiece of item 2, wherein said inlet is provided in said guide track between said first end and said second end.

15. The reversible earpiece of item 1, wherein said receiver is carried on said first body section and said pivot is carried on said second body section.

16. The reversible earpiece of item 15, wherein said guide track is carried on said first body section and said locking ball is carried on said second body section.

17. The reversible earpiece of item 1, wherein said locking ball includes a bulbous head and a neck.

18. The reversible earpiece of item 17, wherein said guide track includes a continuous channel adapted to receive said bulbous head, said first end of said guide track includes a first inlet slot adapted to receive said neck and said second end of said guide track includes a second inlet slot adapted to receive said neck.

19. The reversible earpiece of item 1, wherein said guide track is carried on said first body section and said locking ball is carried on said second body section.

20. The reversible earpiece of item 1, further including a mount adapted to be secured to said head-mounted device.

21. A head-mounted device incorporating the reversible earpiece of any of items 1-20.

22. The head-mounted device of item 21, wherein the head-mounted device comprises a receiver of electromagnetic or acoustic energy.

23. The head-mounted device of item 22, wherein the receiver comprises a camera.

24. The head-mounted device of item 22, wherein the receiver comprises an optical detector selected from a group consisting of a photodiode, a phototransistor, a photomultiplier or combinations thereof.

25. The head-mounted device of item 22, wherein the receiver comprises a spectrometer.

26. The head-mounted device of item 22, wherein the receiver comprises a detector of radio frequency signals.

27. The head-mounted device of item 22, wherein the receiver comprises an acoustic receiver.

28. The head-mounted device of item 27 wherein the acoustic receiver is an ultrasound receiver.

29. The head-mounted device of item 21, wherein the head-mounted device comprises a transmitter of electromagnetic or acoustic energy.

30. The head-mounted device of item 29, wherein the transmitter of electromagnetic energy is an optical source selected from a group consisting of an incandescent bulb, a light emitting diode, a LASER or combinations thereof.

31. The head-mounted device of item 29, wherein the transmitter of acoustic energy is an ultrasound transmitter.

32. The head-mounted device of item 29, wherein the transmitter is used for wireless power transfer including charging a battery or supercapacitor implanted within an eye of an individual.

33. The head-mounted device of item 21, wherein the head-mounted device comprises both a transmitter and receiver (transceiver) of electromagnetic or acoustic energy.

34. The head-mounted device of item 33, wherein the transceiver is comprised of an optical transmitter and receiver.

35. The head-mounted device of item 34, wherein the wavelength of the transmitted light is different from the wavelength of received light.

36. The head-mounted device of item 35, wherein the received light is fluorescence from a device or material in the eye.

37. The head-mounted device of item 33, wherein the transceiver is comprised of a radio frequency transmitter and receiver.

38. The head-mounted device of item 33, wherein the transceiver is an electromagnetic low-frequency inductive sensor.

39. The head-mounted device of item 33, wherein the transceiver is comprised of an acoustic transmitter and receiver (transducer).

40. The head-mounted device of item 39, wherein the acoustic transmitter and receiver operate at ultrasonic frequencies.

41. The head-mounted device of item 21, wherein the head-mounted device comprises a display.

42. The head-mounted device of item 21, wherein the head-mounted device comprises a therapeutic device that delivers electromagnetic energy to the eye.

43. The head-mounted device of item 42, wherein the electromagnetic energy is ultraviolet, visible, and/or infrared light.

44. The head-mounted device of item 43, wherein the ultraviolet, visible, and/or infrared light is chosen to treat neurologic, ophthalmic, and/or psychiatric conditions that are responsive to light therapy.

45. The head-mounted device of item 21, wherein the head-mounted device comprises a monitoring device for communication with (a) a first intraocular device implanted within the first eye, (b) a second intraocular device implanted within the second eye or (c) a first intraocular device implanted within the first eye and a second intraocular device implanted within the second eye.

46. A method of sequentially positioning a head-mounted device in a first operative position in front of a first eye of an individual and a second operative position in front of a second eye of the individual, comprising:
orienting reversible earpieces connected to the head-mounted device into a first position;
positioning the head-mounted device into the first operative position in front of the first eye;
reorienting the reversible earpieces connected to the head-mounted device into a second position; and
positioning the head-mounted device into the second operative position in front of the second eye.

47. The method of item 46, further including rotating the head-mounted device and the reversible earpieces about a rotation axis extending between the reversible earpieces before the positioning of the head-mounted device into the second position.

48. The method of items 46 or 47, further including removing the head-mounted device from the first operative position before the reorienting of the reversible earpieces connected to the head mounted device into the second position.

49. The method of any of items 46-48, further including conducting a therapeutic procedure, a diagnostic procedure or a monitoring procedure of the first eye with the head-mounted device in the first operative position before the reorienting of the reversible earpieces connected to the head mounted device into the second operative position.

50. The method of any of items 46-49, further including conducting a therapeutic procedure, a diagnostic procedure or a monitoring procedure of the second eye with the head-mounted device after the positioning of the head-mounted device into the second operative position in front of the second eye.

Each of the following terms written in singular grammatical form: “a”, “an”, and the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The term “method”, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Terms of approximation, such as the terms about, substantially, approximately, etc., as used herein, refers to ±10% of the stated numerical value. Use of the terms concentric, parallel or perpendicular are meant to mean approximately meeting this condition, unless otherwise specified.

It is to be fully understood that certain aspects, characteristics, and features, of the reversible earpiece 10, the head-mounted device 100 and the method, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the reversible earpiece 10, the head-mounted device 100 and the method which are illustratively described and presented in combination or sub-combination in the context or format of a single embodiment may also be illustratively described and presented in the context or format of a plurality of separate embodiments.

Although the reversible earpiece 10, the head-mounted device 100 and the method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A reversible earpiece for a head-mounted device, comprising:
a first body section;
a second body section having an earpiece;
a pivot and a receiver adapted to receive said pivot wherein said pivot is carried on either of said first body section and said second body section and said receiver is carried on the other of said first body section and said second body section; and
a locking ball and a guide track adapted to receive said locking ball wherein said locking ball is carried on either of said first body section and said second body section and said guide track is carried on the other of said first body section and said second body section.

2. The reversible earpiece of claim 1, wherein said guide track includes an inlet allowing insertion of said locking ball into said guide track and removal of said locking ball from said guide track.

3. The reversible earpiece of claim 2, wherein said guide track includes (a) a first detent adapted to capture and hold said locking ball in a first position at a first end of the guide track and (b) a second detent adapted to capture and hold said locking ball in a second position at a second end of said guide track.

4. The reversible earpiece of claim 2, wherein when said first body section and said second body section are joined, said guide track extends in an arc around said pivot.

5. The reversible earpiece of claim 4, wherein said guide track extends through an arc of about 180 degrees.

6. The reversible earpiece of claim 5, wherein said inlet is provided in said guide track between said first end and said second end.

7. The reversible earpiece of claim 6, wherein said receiver is carried on said first body section and said pivot is carried on said second body section.

8. The reversible earpiece of claim 7, wherein said guide track is carried on said first body section and said locking ball is carried on said second body section.

9. The reversible earpiece of claim 8, wherein said locking ball includes a bulbous head and a neck.

10. The reversible earpiece of claim 9, wherein said guide track includes a continuous channel adapted to receive said bulbous head, said first end of said guide track includes a first inlet slot adapted to receive said neck and said second end of said guide track includes a second inlet slot adapted to receive said neck.

11. The reversible earpiece of claim 1, wherein said guide track is adapted to capture and hold said locking ball in a first position at a first end of the guide track and in a second position at a second end of said guide track.

12. The reversible earpiece of claim 1, wherein when said first body section and said second body section are joined, said guide track extends in an arc around said pivot.

13. The reversible earpiece of claim 1, wherein said guide track extends through an arc of about 180 degrees.

14. The reversible earpiece of claim 2, wherein said inlet is provided in said guide track between said first end and said second end.

15. The reversible earpiece of claim 1, wherein said receiver is carried on said first body section and said pivot is carried on said second body section.

16. The reversible earpiece of claim 15, wherein said guide track is carried on said first body section and said locking ball is carried on said second body section.

17. The reversible earpiece of claim 1, wherein said locking ball includes a bulbous head and a neck.

18. The reversible earpiece of claim 17, wherein said guide track includes a continuous channel adapted to receive said bulbous head, said first end of said guide track includes a first inlet slot adapted to receive said neck and said second end of said guide track includes a second inlet slot adapted to receive said neck.

19. The reversible earpiece of claim 1, wherein said guide track is carried on said first body section and said locking ball is carried on said second body section.

20. The reversible earpiece of claim 1, further including a mount adapted to be secured to said head-mounted device.
